(19) United States
(12) Patent Application Publication
(10) Pub. No.: US 2003/0110029 A1
(43) Pub. Date: Jun. 12, 2003

(54) Noise detection and cancellation in communications systems

(76) Inventors: Masoud Ahmadi, London (GB); Joachim Fouret, London (GB); Marian Neagoe, Woodford Bridge (GB)

Correspondence Address: William M. Lee, Jr., LEE, MANN, SMITH, MCWILLIAMS, SWEENEY & OHLSON, P.O. Box 2786, Chicago, IL, 60690-2786, US

(21) Appl. No.: 10/011,077

(22) Filed: Dec. 7, 2001

(51) Int. Cl. G10L 15/20

(52) U.S. Cl. 704/233

(57) ABSTRACT

Noise is distinguished from speech signals in a communications network by sampling the traffic to provide consecutive frames of samples. An autocorrelation function is calculated for successive sample frames. Measurements are made of the signal energy and a count of zero crossings of the autocorrelation function for each frame. When the signal is found to comprise white noise/unvoiced speech signals, successive frames are compared so as to determine a measure of similarity of frame energy therebetween, a significant number(e.g. five to ten) of similar frames being indicative of noise. Detection of noise may be used in conjunction with echo cancellation to selectively disable this echo cancellation in the presence of noise and absence of speech.

### FIELD OF THE INVENTION

This invention relates to methods and apparatus for detecting and cancelling noise in communications systems, and in particular for distinguishing noise from speech signals.

### BACKGROUND OF THE INVENTION

Modern communications networks use sophisticated techniques for the processing and transport of voice traffic. These techniques include digital encoding and subsequent decoding of the traffic to enable multiplexed transmission. A key requirement for the successful operation of these techniques to deliver a high quality of service to the customer is the ability to distinguish unwanted noise from speech signals some of which may appear to be closely similar to noise. It is also necessary to distinguish noise from the various audio tones that may be employed for signalling purposes in the network.

It will be appreciated that noise detection is required for various purposes in a communications network, including, for example, noise cancellation, background noise measurement and ‘comfort’ noise generation.

In a typical communications network, noise can arise from various sources, including the voice signal source, the transmission medium and the receiver. Noise can also be introduced at various voice processing stages in the transmission process. These include the noise that is associated with the conversion of the voice signal to and from digital form. Typically, this particular form of noise originates from rounding errors and quantisation errors.

It will further be appreciated by those skilled in the art that noise may be deliberately introduced. For example, during periods of voice silence, ‘comfort’ noise (typically pink noise) is often introduced to reassure the listener (caller) that the system is still operational despite the apparent tack of activity and that the call in progress has not been disconnected.

There is thus a need to distinguish not only between different forms of noise, but also between those various forms of noise and speech signals.

It has been found by practitioners in the voice processing and speech analysis art that certain speech signals have some similarity to noise and that it is particularly difficult to distinguish between various low level speech phonemes such as fricatives (consonants) and different types of noise including white and coloured noise.

Speech signals can be classified into approximately fifty different phonemes which can be broadly divided into voiced and unvoiced phonemes, the latter including the low level fricatives. As discussed above, some of these unvoiced phonemes are superficially similar to noise signals, and can be incorrectly identified as such by conventional noise detection and noise cancellation equipment. If these phonemes are mistaken for noise and thus inadvertently cancelled, the processed speech signal assumes an unpleasant ‘clipped’ characteristic which is perceived by the listener to be a serious degradation in voice quality. A further problem is that no two individuals have the same voice pattern, but each has his/her unique ‘voice print’. There is thus no standard voice pattern that could be used as a training template to aid differentiation of voice signals from noise.

Current approaches to the problem of noise detection and cancellation are based on a combination of thresholds and timing. These techniques however suffer from the aforementioned disadvantage of an inability to distinguish effectively and consistently between noise and unvoiced speech phonemes.

### OBJECT OF THE INVENTION

An object of the invention is to minimise or to overcome the above disadvantage.

Another object of the invention is to provide an improved apparatus and method for distinguishing low level unvoiced speech phonemes from noise.

Another object of the invention is to provide an improved apparatus and method for the detection of noise in a communications system carrying voice traffic.

A further object of the invention is to provide an improved echo cancelling equipment for a communications system.

### SUMMARY OF THE INVENTION

According to a first aspect of the invention there is provided a method of distinguishing noise from speech signals in a communications path, the method comprising; storing a sequence of frames of signal samples, comparing successive frames so as to determine a measure of similarity therebetween, and determining the signal to be voice or speech when said successive frames are found to have respectively a low or high similarity.

According to another aspect of the invention there is provided a method of distinguishing noise from unvoiced speech signals in a communications network, the method comprising;

calculating an autocorrelation function for successive sample frames of a received signal;

determining from a measure of signal energy and a count of zero crossings of the autocorrelation function whether the signal comprises voiced speech signals, coloured noise or white noise/unvoiced speech signals; and

when the signal is found to comprise white noise/unvoiced speech signals, comparing said successive frames so as to determine a measure of similarity therebetween, and thereby determining the signal to be voice or noise when said successive frames are found to have respectively a low or high similarity.

The method comprises a two stage discrimination process. In a first stage, those signals that are clearly noise and those that are clearly speech are identified from a measurement of the signal energy and the number of zero crossings of the autocorrelation function. In a second stage, a resolution is then made between the remaining unresolved noise and unvoiced speech signals by comparison of successive frames to determine repeatability or non-repeatability of those frames. Successive frames of noise have a high degree of similarity, whereas successive frames of unvoiced speech show little similarity.

Noise is distinguished from speech signals in a communications network by sampling the traffic to provide consecutive frames of samples. An autocorrelation function is calculated for successive sample frames. Measurements are made of the signal energy and a count of zero crossings of the autocorrelation function for each frame. When the signal is found to comprise white noise/unvoiced speech signals, successive frames are compared so as to determine a measure of similarity of frame energy therebetween, a significant number(e.g. five to ten) of similar frames being indicative of noise. Detection of noise may be used in conjunction with echo cancellation to selectively disable this echo cancellation in the presence of noise and absence of speech.

The method may be embodied in software in machine readable form on a storage medium.

According to another aspect of the invention there is provided apparatus for distinguishing noise from speech signals in a communications path, the apparatus comprising; a store for storing a sequence of frames of signal samples, and comparison means for comparing successive frames so as to determine a measure of similarity therebetween, and thereby determine the signal to be speech or noise when said successive frames are found to have respectively a low or high similarity.

According to another aspect of the invention there is provided apparatus for distinguishing noise signals from voiced and unvoiced speech signals in a communications network, the apparatus comprising; sampling and calculating means for calculating an autocorrelation function for successive sample frames of a received signal; means for determining from a measure of signal energy and a count of zero crossings of the autocorrelation function whether the signal comprises voiced speech signals, coloured noise or white noise/unvoiced speech signals; and comparison means for comparing said successive frames so as to determine a measure of similarity therebetween, and thereby determining the signal to be voice or noise then said successive frames are found to have respectively a low or high similarity.

Advantageously, the noise detection arrangement is used in conjunction with an echo canceller or adaptive filter to provide noise cancellation and to suppress echo cancelling in the absence of speech thus maintaining a high quality of voice transmission.

According to another aspect of the invention there is provided echo cancelling apparatus for a communications network, said apparatus comprising:

an echo cancelling circuit and detection apparatus associated therewith for discriminating between speech and noise so as to disable the echo cancelling circuit in the presence of noise;

wherein the noise discrimination apparatus comprises a storage means for storing a sequence of frames of signal samples, and comparison means for comparing successive stored frames so as to determine a measure of similarity therebetween, and thereby determine the signal to be speech or noise when said successive frames are found to have respectively a low or high similarity.

### BRIEF DESCRIPTION OF THE DRAWINGS

An embodiment of the invention will now be described with reference to that accompanying drawings in which:

FIG. 1 shows in schematic form a near end of a voice transmission circuit incorporating noise detection;

FIGS. 2 to 6 are graphical representations of noise, voiced and unvoiced speech signals;

FIG. 7 is a flow diagram illustrating a preferred method of determining frame energy and the number of zero crossings of the autocorrelation function;

FIG. 8 is a flow diagram illustrating a preferred method of distinguishing between speech and noise signals; and

FIG. 9 shows in schematic form an apparatus for performing the method of FIGS. 7 and 8.

### DESCRIPTION OF PREFERRED EMBODIMENT

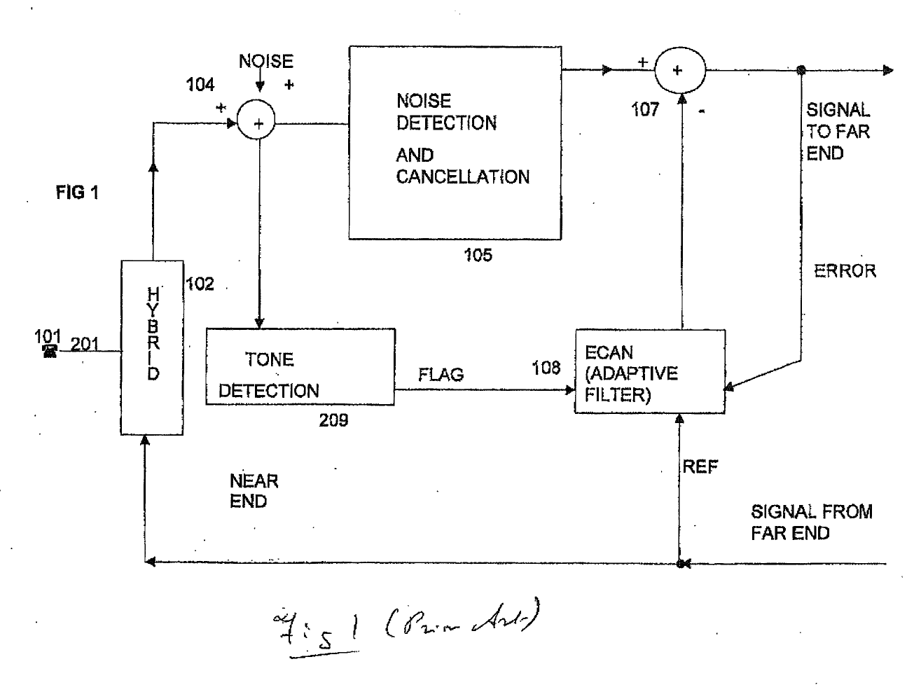

Referring first to FIG. 1, this shows an exemplary near end voice transmission circuit in which noise detection and cancellation are employed in association with echo cancelling to deliver a high quality voice service. Voice signals from telephone set 101 are fed via a hybrid 102 to noise detection and cancellation circuitry 105 and to a tone detector 209, the latter providing detection of the various audio tones, e.g. DTMF tones and modem tones that are used for signalling and similar purposes. The intrusion of noise into the voice signal is depicted schematically as a noise source 104, although it will of course be understood that this noise source is not a physical component. Echoes on the line 110 resulting e.g. from mismatch with the hybrid 102 are suppressed by echo cancelling circuit (ECAN) or adaptive filter 108. The ECAN has an output to summing function 107, the latter also receiving the output of the noise detector 105. The ECAN 108 receives flag signals from the tone detector 209 which disable the ECAN in the presence of signalling tones. A suitable tone detector is described in our co-pending application Ser. No. 09/776,620. The noise detector and cancellation circuit 105 precedes the EGAN 108 and provides selective disabling of the ECAN in the presence of noise and the absence of speech. This improves the performance of the ECAN or adaptive filter whose functionality can be downgraded by near end noise.

The general principles of echo cancellation and adaptive filtering will be understood by those skilled in the art.

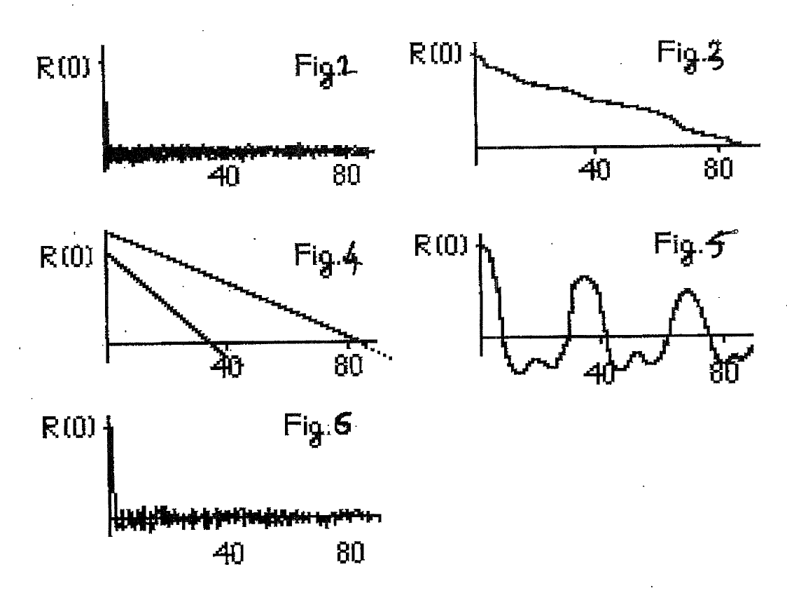

Reference is now made to FIGS. 2 to 6 which illustrate graphically the various forms of noise and of voiced and unvoiced speech that occur in a communications network. In these figures, the vertical axis represents the measure of the autocorrelation function and the horizontal axis represents the number of samples over which the autocorrelation function is taken.

In our arrangement and method, the detection of noise and its differentiation from speech signals comprises a two stage process. In a first stage an autocorrelation function is calculated and is used, together with a measure of the signal energy to distinguish those signals that are clearly noise or voiced speech. A second stage resolves remaining signals which are then identified as noise or unvoiced speech.

The received signal can be considered as a time series x(k) displaying autocorrelation properties. The auto-correlation function is a measure of how similar a time series x(k) is to itself shifted in time by n creating the new series x(n+k)

The autocorrelation function (ACF) of a received signal is thus defined for a number of samples N as—

$$ACF ( n ) = {\sum }_{k = - N}^{N} x ( k ) x ( n + k ) , N = 240$$

Typically, the number N of samples is two hundred and forty, but it will be understood that this value is arbitrary and that a greater or fewer number of samples may be employed. This number of samples is divided into six groups of forty samples. A set of forty samples will be referred to below as a frame.

We have found unexpectedly that different types of speech and coloured noise can be reliably identified by their signal energies and the characteristics of their autocorrelation functions. These significant characteristics of speech and noise signals are summarised in Table 1 below.

TABLE 1

| | | | Signal | | |
|---|---|---|---|---|---|
| Type of Signal | R(0) = | R(0)/R(n) | Level db | ZCR min. | ZCR max. |
| White (W) | 0.025 | >5 | −37 | 100 | 140 |
| noise | | | | | |
| Pink (P) | 0.1 | <2 | −37 | 9 | 77 |
| noise | | | | | |
| Brown (B) | 0.14 | <2 | −36 | 0 | 11 |
| noise | | | | | |
| P + B noise | 0.12 | <2 | −37 | 0 | 60 |
| P + W noise | 0.041 | <2 | −37 | 24 | 116 |
| B + W noise | 0.07 | <2 | −36 | 0 | 100 |
| Speech | 1 | <2 | −18 | 15 | 150 |
| Tones | 1 | <2 | −11 | 8 | 47 |
| DTMF | 1 | <2 | −11 | 19 | 30 |

In Table 1 above, R(0) represents the energy of the input signal, and R(n) is a side maximum of the autocorrelation function for index n=24 . . . 112. ZCR min and ZCR max are respectively the upper and lower limits of the number of zero crossings of the autocorrelation function (ACF). In Table 1, the values given for speech signals incorporate both voiced and unvoiced speech. In particular, it will be note that the range of zero crossings for speech overlaps with that of white noise thus leading to potential confusion between the two types of signal as will be discussed below.

For the purposes of analysis, we employ the first eighty samples, i.e. two frames of forty samples, of the autocorrelation function (ACF). We have found that the shape or configuration of the autocorrelation function is well characterised by the number of zero crossings (ZCR) for these first eighty samples starting from R(0). For white noise, we have a peak in R(0) and the number of zero crossings (ZCR) is high (−32). For “coloured” noise, or a combination of coloured noises, the number of zero crossings (ZCR) is very low (−3). Voiced speech has a medium number of zero crossings (3=ZCR=15) and a high energy. Unvoiced speech (consonants or fricatives) has a high the number of zero crossings (−36) and can thus be confused with white noise if comparison is made solely on the number of zero crossings. The characteristics of these various forms of noise and speech are illustrated graphically in FIGS. 2 to 6 of the accompanying drawings.

FIGS. 2, 3 and 4 illustrate typical autocorrelation function patterns for white, pink and brown noise respectively. In each of these figures, the signal energy is shown graphically for the first eighty samples of a frame. FIG. 5 shows a corresponding ACF pattern for voiced speech, and FIG. 6 shows the ACF pattern for low level unvoiced speech that is characteristic of fricatives. It will be apparent from FIGS. 2 and 6 that the autocorrelation function for unvoiced speech is similar to that of white noise.

To overcome this problem of close similarity between white noise and unvoiced speech, we employ a further criterion which is based on our observation that speech is a non-repetitive signal in the long term, whereas white noise is repetitive in nature.

We have found that examination of a number of successive frames provides a clear and reliable distinction between white noise and unvoiced speech. In particular, we have found that five to ten successive frames are sufficient to provide an adequate degree of reliability. Specifically, frames of white noise over a period of time are substantially similar to each other, whereas frames of unvoiced speech have only a small degree of similarity. Thus, by determining whether the energy of the signal is, or is not, repeatable over a sufficient number of frames, we can determine whether that signal comprises noise or unvoiced speech.

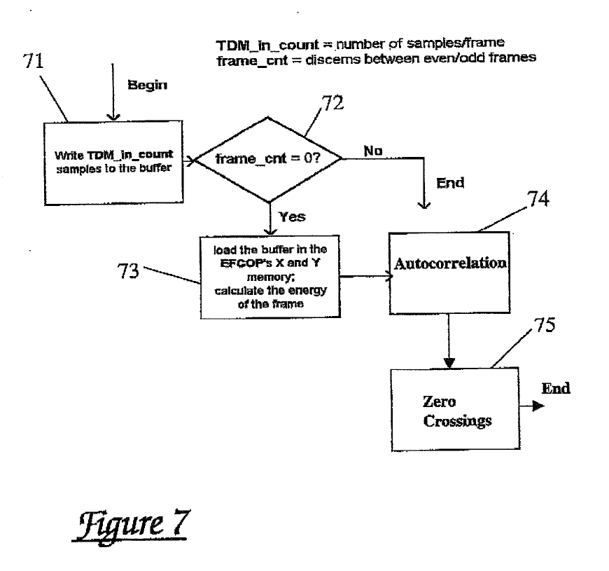

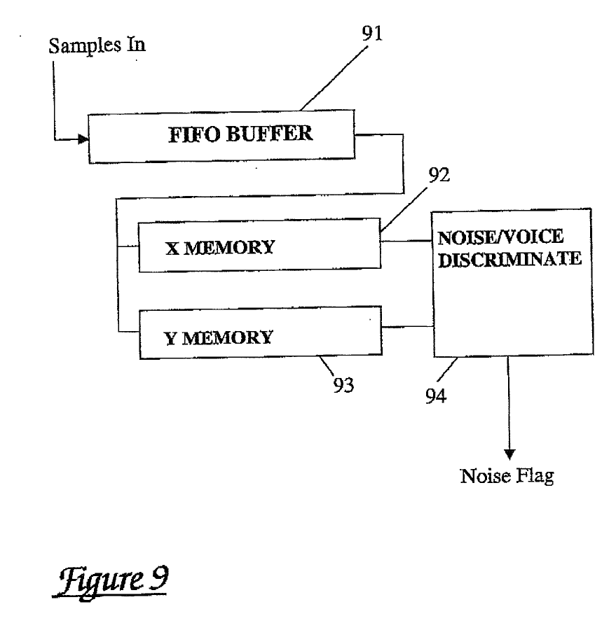

Referring now to FIG. 7, this illustrates in flow chart form the process for calculating the correlation function, determining the number of zero crossings and for calculating the energy of a frame of samples. This process operates on sample data stared in a first-in-first-out buffer 91 (FIG. 9) which has a capacity of two hundred and forty samples, i.e. six frames each of forty samples, the frames being numbered in sequential order, and being stored in the buffer in that order. The number of samples per frame is stored (71) and a determination is made at step 72 as to whether the frame number is odd or even, i.e. the frame number is determined modulo two. If the frame number is odd, no action is taken. If however the frame number is even, the two hundred and forty buffered samples are loaded into first and second memories 92, 93 (FIG. 9) referred to as the X and Y memory and a value of the frame energy is calculated at step 73. Next, a value of the autocorrelation function is determined at step 74, after which the first eighty samples, i.e. the first two stored frames, are examined to determine a zero crossing count at step75.

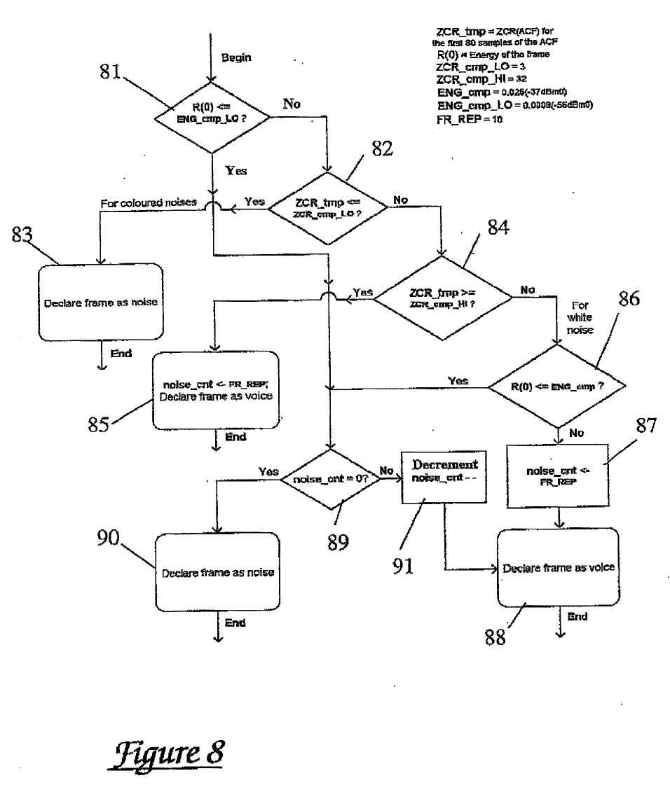

Having determined frame energy, the autocorrelation function value and the number of zero crossings, we next determine whether the frame of samples represents noise or speech. The algorithm employed, which is illustrated in the flow chart of FIG. 8 and is embodied in the noise/voice discriminator 94 of FIG. 9, operates on successive sets of forty samples, i.e. individual frames. Identification of noise frames activates a noise flag output, e.g. to provide control of echo cancelling equipment. Effectively, the algorithm distinguishes coloured noise from other signals, and processes those other signals to distinguish between white noise and speech. The arrangement of FIG. 9 may for example be employed in echo cancelling apparatus in a communications network node.

The algorithm maintains a count of consecutive similar frames of similar frame energy. This is achieved by counting down from a starting or reset value for each consecutive similar frame, the count reaching zero after a number of such frames. The count is reset to its starting value for consecutive frames of dissimilar energy, this being indicative of speech. A zero value of the noise count is taken as being indicative of a white noise signal. We have found that a repetition or similarity of from five and ten frames, i.e. a counter start value of from five to ten, is sufficient to provide a reliable determination between noise and speech signals.

As shown in FIG. 8, the measured frame energy R(0) from step 73 (FIG. 7) is compared at step 81 with a first reference value Eng_cmp₁₃ LO which is set at a minimum threshold value, e.g. −56 dBm0. If the frame energy is less than or equal to this reference value, i.e. an indication that the frame may possibly comprise noise, an evaluation at step 89 is made of the noise count. If this noise count is zero thus indicating a sequence of similar frames, then the current frame is declared (90) as noise. If however the noise count has not reached zero, the count is decremented by one (91) and the current frame is declared (88) as voice.

If the energy of the frame is determined at step 81 to be greater than the minimum threshold value Eng_cmp_LO, the zero crossing count (ZCR_tmp) of the first eighty samples of the correlation function is compared at step 82 with a first reference value ZCR_cmp_LO (typically 3). If the zero crossing count is found to be less than or equal to this reference value (indicative of coloured noise), the frame is declared or confirmed at step 83 as coloured noise.

If the zero crossing count is greater than the first reference value ZCR_cmp_LO, a comparison is next made at step 84 with a second (higher) reference value ZCR_cmp_HI (typically 32). If the zero crossing count exceeds or is equal to this second reference value, the frame is declared at step 89 as voice and the noise count is reset to its start value. If however the zero crossing count is less than the second reference value ZCR_cmp_HI, i.e. an indication that the frame may comprise either speech or white noise, a further comparison at step 86 determines whether the frame energy R(0) is less than or equal to a second threshold value ENG_cmp, (typically −37 dBm0). If the frame energy is less than or equal to this reference value, an evaluation at step 89 is made of the noise count. If this noise count is zero thus indicating a sequence of similar frames, then the current frame is declared (90) as noise. If however the noise count has not reached zero, the count is decremented by one (91) and the current frame is declared at step 88 as voice. If the frame energy R(0) is determined at step 86 to be greater than this second threshold value ENG_cmp, the noise frame count is reset at step 87 and the frame is declared as voice at step 88.

It will be understood that the above description of a preferred embodiment is given by way of example only and that various modifications may be made by those skilled in the art without departing from the spirit and scope of the invention. Any range or value given herein may be extended or altered without losing the effect sought, as will be apparent to the skilled person from an understanding of the teachings herein.

1. A method of distinguishing noise from speech signals in a communications path, the method comprising; storing a sequence of frames of signal samples, comparing successive frames so as to determine a measure of similarity therebetween, and determining the signal to be speech or noise when said successive frames are found to have respectively a low or high similarity.

2. A method as claimed in claim 1, wherein the communications path includes an echo canceller, and wherein the method includes disabling the echo canceller in the absence of speech signals and the presence of noise signals.

3. A method as claimed in claim 2, wherein said comparison is effected for five to ten sample frames.

4. A method as claimed in claim 3, wherein said comparison is effected between consecutive frames having a frame energy less than a predetermined threshold.

5. A method as claimed in claim 1, and embodied as software in machine readable form on a storage medium.

6. A method of distinguishing noise from unvoiced speech signals in a communications network, the method comprising;
calculating an autocorrelation function for successive sample frames of a received signal;
determining from a measure of signal energy and a count of zero crossings of the autocorrelation function whether the signal comprises voiced speech signals, coloured noise or white noise/unvoiced speech signals; and
when the signal is found to comprise white noise/unvoiced speech signals, comparing said successive frames so as to determine a measure of similarity therebetween, and thereby determining the signal to be voice or noise when said successive frames are found to have respectively a low or high similarity.

7. A method as claimed in claim 6, wherein the communications path includes an echo canceller, and wherein the method includes disabling the echo canceller in the absence of speech signals and the presence of noise signals.

8. A method as claimed in claim 7, wherein a count is maintained of consecutive frames having a similar frame energy, and wherein, when that counter reaches a predetermined value, further consecutive frames having that similar frame energy are identified as noise.

9. A method as claimed in claim 8, wherein said comparison is effected for five to ten sample frames.

10. A method as claimed in claim 6, and embodied as software in machine readable form on a storage medium.

11. Apparatus for distinguishing noise from speech signals in a communications path, the apparatus comprising; a store for storing a sequence of frames of signal samples, and comparison means for comparing successive frames so as to determine a measure of similarity therebetween, and thereby determine the signal to be speech or noise when said successive frames are found to have respectively a low or high similarity.

12. Apparatus for distinguishing noise signals from voiced and unvoiced speech signals in a communications network,, the apparatus comprising;
sampling and calculating means for calculating an autocorrelation function for successive sample frames of a received signal;
means for determining from a measure of signal energy and a count of zero crossings of the autocorrelation function whether the signal comprises voiced speech signals, coloured noise or white noise/unvoiced speech signals; and
comparison means for comparing said successive frames so as to determine a measure of similarity therebetween, and thereby determining the signal to be voice or noise when said successive frames are found to have respectively a low or high similarity.

13. Apparatus as claimed in claim 8, wherein the communications path includes an echo canceller, and wherein the apparatus includes means for disabling the echo canceller in the absence of speech signals and the presence of noise signals.

14. Echo cancelling apparatus for a communications network, said apparatus comprising:
an echo cancelling circuit and detection apparatus associated therewith for discriminating between speech and noise so as to disable the echo cancelling circuit in the presence of noise;
wherein the noise discrimination apparatus comprises a storage means for storing a sequence of frames of signal samples, and comparison means for comparing successive stored frames so as to determine a measure of similarity therebetween, and thereby determine the signal to be speech or noise when said successive frames are found to have respectively a low or high similarity.

15. A communications network node incorporating echo cancelling apparatus as claimed in claim 14.
